(19) United States
(12) Patent Application Publication
(10) Pub. No.: US 2011/0122076 A1
(43) Pub. Date: May 26, 2011

(54) POSITION DETECTION APPARATUS FOR A TOUCH PANEL

(75) Inventor: HERMAN, HSINCHU COUNTY (TW)

(73) Assignee: SITRONIX TECHNOLOGY CORP., HSINCHU COUNTY (TW)

(21) Appl. No.: 12/835,205

(22) Filed: Jul. 13, 2010

(30) Foreign Application Priority Data
Nov. 20, 2009 (TW) 098139654

(51) Int. Cl. G06F 3/041

(52) U.S. Cl. 345/173

(57) ABSTRACT

The present invention provides a position detection apparatus for a touch panel. The apparatus includes at least one light source disposed on at least a first edge of the touch panel for illumination of a surface of the touch panel, a first detector disposed on one end of a second edge of the touch panel, and a second detector disposed on the other end of the second edge of the touch panel, wherein each of the first and second detectors comprises a plane mirror reflecting an image from the surface of the touch panel and an image sensor for acquisition of the image from the plane mirror, and a position where a pointer touches the touch panel is determined according to the images acquired by the image sensors of the first and second detectors.

### BACKGROUND OF THE INVENTION

1. Field of the Invention

The present invention is related to a touch panel, more particularly, to a position detection apparatus for a touch panel.

2. Description of the Prior Art

In 1970, touch panels are originated for military usage in United States of America. Until 1980, technologies related to touch panel were published and utilized to be other commercial applications. The traditional input device such as keyboard, mouse, trackball, track point, does not meet the user's requirement of convenience. Due to its simplicity and convenience of operation, the touch panel has been universally applied to many consumer electronic products and developed from a minor into key component in the products. It is even expected that a whole new integrated industry of touch panel will be formed in the near future.

The touch panel is an input device directly attached to the screen of a CRT or liquid crystal display, whereby users can perform input operations by simply pressing the screen using a pointer such as their fingers or a stylus. The touch panel has a wide range of application including those in: (1) portable electronic products or communication devices, such as PDAs, tablet PCs, digital cameras or 3G mobile phones, (2) transaction or business systems, such as ATMs, sale systems or videoconferencing systems, (3) industrial systems, such as automatic control systems, centralized monitor systems or workstation systems, and (4) public services, such as tutorial, introduction or information service system at airports, railway stations or marketplace.

There are many different schemes for detection of the touched position of the pointer on the touch panel, including resistive and capacitive detection respectively used in so called resistive and capacitive touch panels. Besides, optical detection is also successfully developed now. In the resistive touch panel, the touched position is detected by depression of the surface of the panel. A pressure must be applied through the pointer onto the panel, producing a change in resistance detected by a control circuit for calculation of coordinates of the touched position. If users push too much on the panel, the panel or whole product may be damaged. Further, the indispensable transparent resistive layer on the panel reduces the luminance of the display.

The capacitive touch panel consists of glass coated with a metal layer. The contact of the pointer with the surface of the panel produces a change in capacitance detected by the control circuit for calculation of coordinates of the touched position. However, only a pointer made of conductive material is suitable, such as user's finger, which causes limitation in use. Similarly, the indispensable metal-coated glass layer on the panel also reduces the luminance of the display.

The optical touch panel acquires images from the surface of the panel using image sensors and accordingly calculates coordinates of the touched position of the pointer. Accuracy of coordinate calculation of the touched position depends on the clarity of image. Thus, in optical touch panel, image acquisition is still an important topic to be researched for improvement. Due to the advantages of the optical touch panel, there are many different types of optical touch panel which have been disclosed, such as those in U.S Patent Application No. 2004/0149892A1 and 2009/0145973, and U.S. Pat. No. 7,274,352B2 and 7,538,759B2. However, in the previously described optical touch panel, use of the multiple light sources illuminating the surface of the panel increases the power consumption and product cost.

Additionally, U.S Patent Application No. 2007/0089915A1 discloses a position detection apparatus including a prism mirror, an image sensor and a lens, wherein the prism mirror is placed between the image sensor and the lens, the image from the lens is inflected to the image sensor for image acquisition. However, due to use of the prism mirror, such a position detection apparatus has a high product cost and structure complexity. Even worse, a pointer with a surface having reflective textures can not be used.

Therefore, an improved position detection apparatus for an optical touch panel having a low product cost and power consumption is necessary to eliminate the above issues in the prior art.

### SUMMARY OF THE INVENTION

One of the objects of the present invention is to provide a position detection apparatus for a touch panel including a plane mirror reflecting the image of the surface of the panel to two detectors on the ends of one edge of the panel for image acquisition, which reduces the product cost.

Another one of the objects of the present invention is to provide a position detection apparatus for a touch panel including detectors arranged in parallel with the panel, which reduces the thickness of the touch panel.

Still another one of the objects of the present invention is to provide a position detection apparatus for a touch panel including light guides on edges of the panel guiding light from the light source so that the surface of the panel is uniformly illuminated, which enhances the clarity of the images acquired by the detectors and the accuracy of calculation of the touched position.

The present invention provides a position detection apparatus for a touch panel. The apparatus includes at least one light source disposed on at least a first edge of the touch panel for illumination of a surface of the touch panel, a first detector disposed on one end of a second edge of the touch panel, and a second detector disposed on the other end of the second edge of the touch panel, wherein each of the first and second detectors comprises a plane mirror reflecting an image from the surface of the touch panel and an image sensor for acquisition of the image from the plane mirror, and a position where a pointer touches the touch panel is determined according to the images acquired by the image sensors of the first and second detectors.

The position detection apparatus for a touch panel according to one embodiment of the present invention further includes at least one light guide on at least one edge of the touch panel to receive and guide the light from the light source, whereby the surface of the panel is uniformly illuminated with reduced number of light sources. This also reduces the product cost.

### DETAILED DESCRIPTION OF PREFERRED EMBODIMENTS

FIG. 1 is a top view of a touch panel equipped with a position detection apparatus according to one embodiment of the invention. The position detection apparatus includes at least one light source 20, a first detector 30 and a second detector 35. The light source 20 is disposed one edge of the touch panel 10. In this embodiment, two light sources 20 are included and disposed on the ends of the long side of the touch panel 10 for emitting light illuminating the surface of the touch panel 10. The first and second detectors 30 and 35 are respectively disposed on a first and second ends of the edge of the touch panel 10 for acquiring images from the surface of the touch panel 10. The acquired images are processed by an image processor (not shown) which calculates a coordinate of the touched position of a pointer on the touch panel 10 using the images and the positions of the first and second detectors 30 and 35. The coordinate thus derived is sent to a host for further processing. The pointer may be the user's finger or a stylus. It is noted that the first and second detectors 30 and 35 are disposed on the ends of the long side of the touch panel 10.

For uniform illumination of the surface of the touch panel 10 by the light sources 20, at least one light guide 21 is included. In this embodiment, there are three light guides 21 respectively disposed on three edges of the touch panel 10, each receiving and guiding light from one of the light sources 20 to uniformly illuminate the surface of touch panel 10. The light guides 21 may be optical fibers or made of acrylics, and the light sources 20 may be LEDs. In comparison with the traditional optical touch panel using a large number of light sources, the touch panel 10 has a low product cost and power consumption since the surface of the touch panel 10 is uniformly illuminated using only a small number of light sources 20.

FIG. 2 is a top view of a touch panel equipped with a position detection apparatus according to another embodiment of the invention. The touch panel shown in FIG. 2 is different from that in FIG. 1 by having two more light sources 20 on the ends of the other long side of the touch panel 10 and two more light guides on another two edges of the touch panel 10. That is to say, the touch panel 10 in FIG. 2 has four light sources respectively disposed at its four corners, and three light guides on the three edges of the touch panel 10 receiving and guiding the light from the four light sources. Thus, the illumination of the surface of the touch panel 10 is enhanced. Such a position detection apparatus is suitable for large size panels.

FIGS. 3 and 4 are respectively a stereograph and a side view of a detector in a position detection apparatus for a touch panel according to one embodiment of the invention. The detector 40 includes a plate 42, a plane mirror 44 and an image sensor 46. The detector 40 may be one of the first and second detectors 30 and 35 shown in FIGS. 1 and 2. The plane mirror 44 is disposed on the plate 42 and forms an angle of 43°˜47° with the plate 42. The angle between the plane mirror 44 and plate 42 is preferably 45°. The plate 42 has a through hole 43 located under the plane mirror 44. The image sensor 46 is disposed below the through hole 43 and faces to the plane mirror 44. The plane mirror 44 reflects the image from the surface of the touch panel 10 through the through hole 43 to the image sensor 46 which then sends the acquired image to an image processor for further processing. When the pointer touches the panel 10, it blocks part of the light incident to the image sensor and causes a shadow at the touched position. Thus, the image acquired by the image sensor 46 also includes a shadow at the touched position. The image processor calculates the coordinate of the shadow to determine the touched position in the touch panel 10.

Since the first and second detectors 30 and 35 are respectively disposed on two ends of the edge of the touch panel 10, they acquire the images of the surface of the touch panel 10 from different viewpoints. Thus, the coordinate of the shadow at the touch position can be calculated based on the images acquired by the first and second detectors 30 and 35. Thus derived coordinate of the touched position is further sent to a host for further processing. The detector 40 has a lower cost and simpler structure than the traditional detector since the image of the surface of the touch panel 10 is acquired using only the plane mirror 44 and image sensor 46. Furthermore, the image sensor 46 “lies” on (in parallel with) rather than “stands” on (in perpendicular to) the plate 42 so that it faces to the plane mirror 44. Thus, the thickness of the touch panel is reduced.

Nevertheless, the image sensor 46 may stand on the plate 42 if the thickness of the touch panel is irrelevant in certain circumstances. The plate 42 is also optional, and the plane mirror 44 may be disposed on the touch panel 10 while the image sensor 46 may be disposed under the plane mirror 44.

The detector 40 further includes a lens 48 disposed below the plate 42 and under the plane mirror 44 while the image sensor 46 is disposed below the lens 48. The lens 48 provides a focused image to the image sensor 46 for enhancement of the image clarity. The lens 48 is accommodated in a shell 49 so that it can move upward or downward to adjust the focus.

FIG. 5 is a stereograph of a frame and a supporting shell used in a position detection apparatus for a touch panel according to one embodiment of the invention. The frame 22 is disposed around the edges of the touch panel 10. The supporting shell 24 is disposed on the frame 22 for fixing the light guide 21 to the edge of the touch panel 10. The supporting shell 24 is in the form of a semi-cylinder with the open side facing to the center of the panel 10 so that the light transmitted in the light guide 21 can be projected to the surface of the touch panel 10. The color of the supporting shell 24 may be white for reflection of light to the surface of the touch panel 10. The supporting shell 24 may be integrated with the frame 22. Alternatively, the supporting shell 24 may be directly disposed on the touch panel 10 without using the frame 22.

FIG. 6 is a stereograph of a light source holder and light guide sockets used in a position detection apparatus for a touch panel according to one embodiment of the invention. The two light guide sockets 27 are fixed on one side of the light source holder and joins to the supporting shell 24 (shown in FIG. 5). The light source holder accommodates the light source 20 (shown in FIG. 1). This structure is applied to the touch panel shown in FIG. 1. One end of the light guide 21 is inserted into the light guide socket 27 so that the light guide 21 is securely accommodated in the supporting shell 24. The light from the light source 20 is received by the light guide 21 at the joint of the holder 26 and the socket 27, and transmitted in the light guide 20 to be projected onto the surface of the touch panel 10.

FIG. 7 is a stereograph of a light source holder and a light guide socket used in a position detection apparatus for a touch panel according to one embodiment of the invention, which is applied to the touch panel 10 having four light sources 20 shown in FIG. 2. Only one light guide socket 29 for insertion of the light guide 21 is fixed on one side of the light source holder 28 accommodating the light source 20.

In conclusion, the present invention provides a position detection apparatus for a touch panel. The apparatus includes at least one light source disposed on at least a first edge of the touch panel for illumination of a surface of the touch panel, a first detector disposed on one end of a second edge of the touch panel, and a second detector disposed on the other end of the second edge of the touch panel, wherein each of the first and second detectors comprises a plane mirror reflecting an image from the surface of the touch panel and an image sensor for acquisition of the image from the plane mirror, and a position where a pointer touches the touch panel is determined according to the images acquired by the image sensors of the first and second detectors. Due to the simplicity of its structure, the position detection apparatus of the present invention has the advantage of low product cost, low power consumption and a reduced thickness.

### BRIEF DESCRIPTION OF DRAWINGS

FIG. 1 is a top view of a touch panel equipped with a position detection apparatus according to one embodiment of the invention.

FIG. 2 is a top view of a touch panel equipped with a position detection apparatus according to another embodiment of the invention.

FIGS. 3 and 4 are respectively a stereograph and a side view of a detector in a position detection apparatus for a touch panel according to one embodiment of the invention.

FIG. 5 is a stereograph of a frame and a supporting shell used in a position detection apparatus for a touch panel according to one embodiment of the invention.

FIG. 6 is a stereograph of a light source holder and light guide sockets used in a position detection apparatus for a touch panel according to one embodiment of the invention.

FIG. 7 is a stereograph of a light source holder and a light guide socket used in a position detection apparatus for a touch panel according to one embodiment of the invention

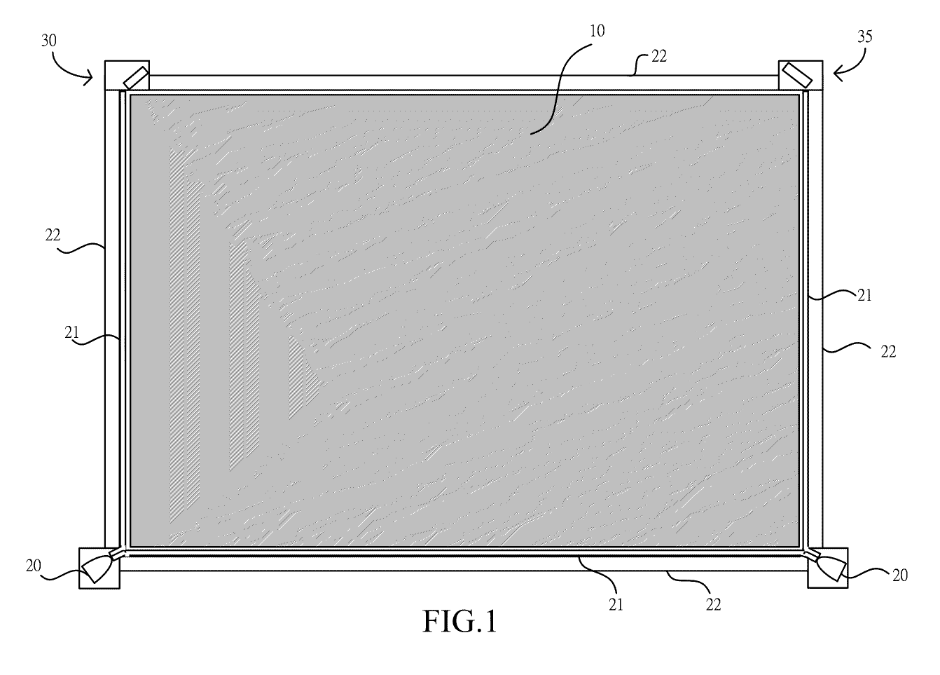

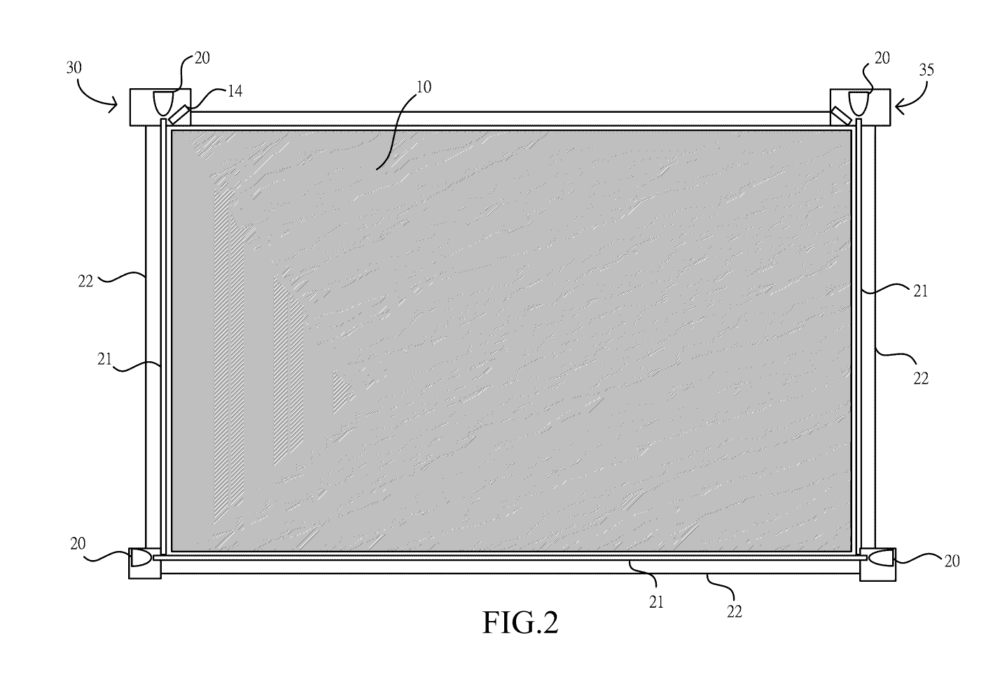

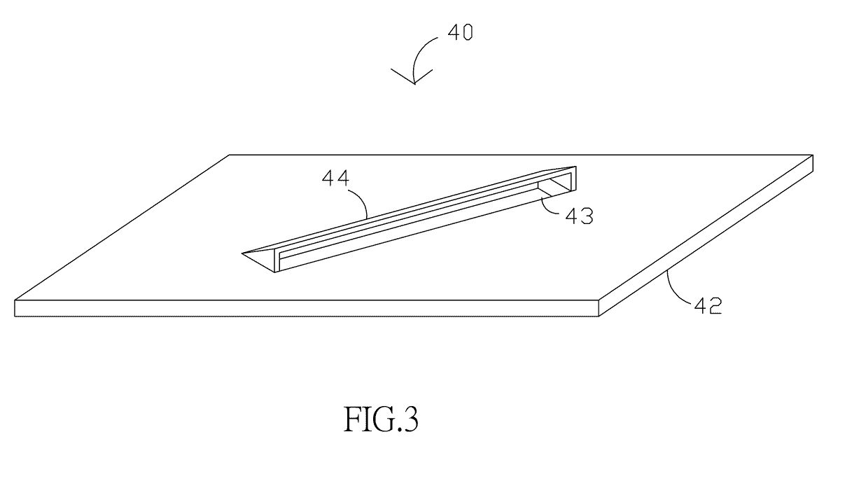

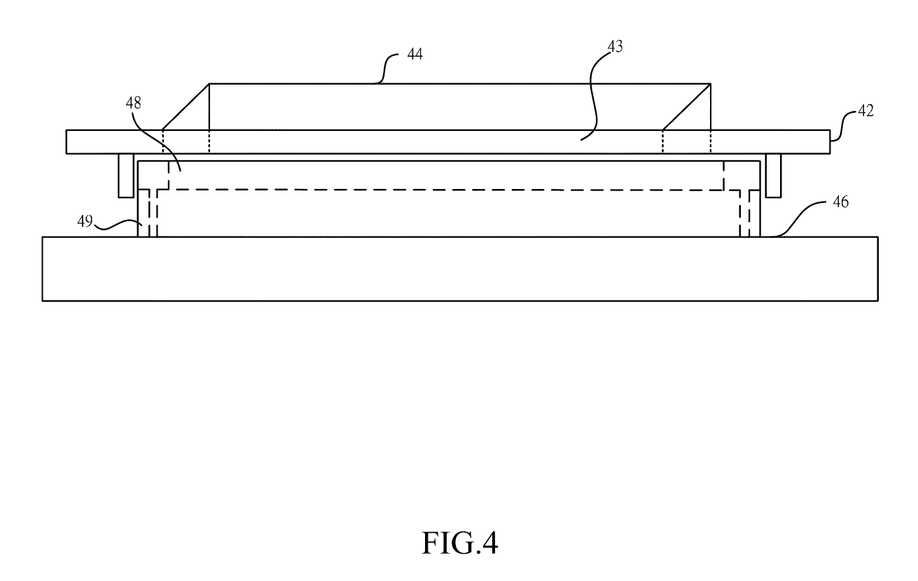

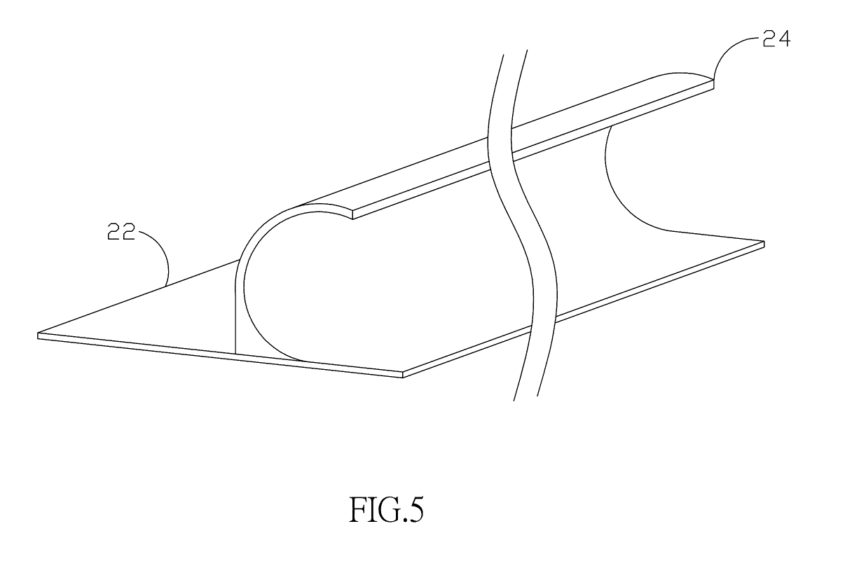

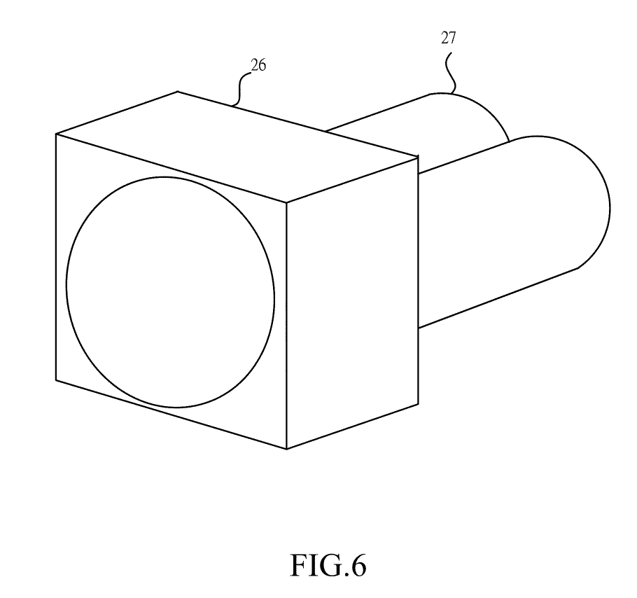

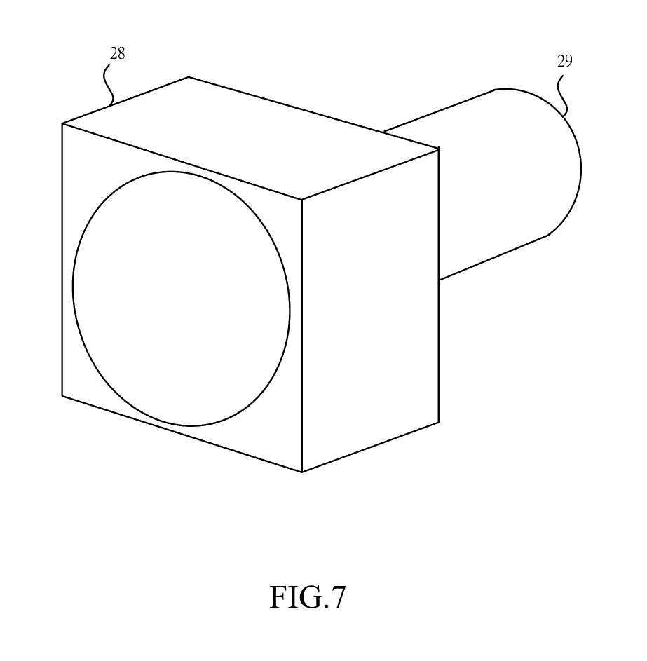

What is claimed is:

1. A position detection apparatus for a touch panel comprising:
at least one light source disposed on at least a first edge of the touch panel for illumination of a surface of the touch panel;
a first detector disposed on one end of a second edge of the touch panel; and
a second detector disposed on the other end of the second edge of the touch panel;
wherein each of the first and second detectors comprises a plane mirror reflecting an image from the surface of the touch panel and an image sensor for acquisition of the image from the plane mirror, and a position where a pointer touches the touch panel is determined according to the images acquired by the image sensors of the first and second detectors.

2. The position detection apparatus for a touch panel as claimed in claim 1, wherein the image sensors are disposed below the plane mirrors.

3. The position detection apparatus for a touch panel as claimed in claim 1, wherein in each of the first and second detectors, an angle between the plane mirror and the touch panel ranges from 43° to 47°.

4. The position detection apparatus for a touch panel as claimed in claim 3, wherein an angle between the plane mirror and the touch panel is 45°.

5. The position detection apparatus for a touch panel as claimed in claim 1, wherein each of the first and second detectors further comprises:
a plate on which the plane mirror is disposed, having a through hole located under the plane mirror and below which the image senor is disposed facing to the plane mirror.

6. The position detection apparatus for a touch panel as claimed in claim 1, wherein each of the first and second detectors further comprises:
a lens disposed under the plane mirror and below which the image sensor is disposed.

7. The position detection apparatus for a touch panel as claimed in claim 1, wherein the second edge is a long side of the touch panel.

8. The position detection apparatus for a touch panel as claimed in claim 1 further comprising:
at least one light guide on at least one edge of the touch panel to receive and guide the light from the light source.

9. The position detection apparatus for a touch panel as claimed in claim 8, wherein the light guide is an optical fiber or composed of acrylics.

10. The position detection apparatus for a touch panel as claimed in claim 8 further comprising:
at least one supporting shell on the edge of the touch panel where the light guide is disposed and for accommodation of the light guide.

11. The position detection apparatus for a touch panel as claimed in claim 10 further comprising:
a holder accommodating the light source; and
at least one light guide socket which is fixed on one side of the holder and into which one end of the light guide is inserted.

12. The position detection apparatus for a touch panel as claimed in claim 10 further comprising:
a frame around the touch panel on which the supporting shell is disposed.

13. The position detection apparatus for a touch panel as claimed in claim 12, wherein the frame is integrated with the supporting shell.

14. The position detection apparatus for a touch panel as claimed in claim 1, wherein the light source is an LED.
